(19) United States
(12) Patent Application Publication
(10) Pub. No.: US 2019/0242361 A1
(43) Pub. Date: Aug. 8, 2019

(54) Apparatus and Method for Deriving Useful Energy from a Flowing Fluid

(71) Applicant: SaeHeum Song, Skillman, NJ (US)

(72) Inventor: SaeHeum Song, Skillman, NJ (US)

(21) Appl. No.: 16/106,461

(22) Filed: Aug. 21, 2018

Related U.S. Application Data
(63) Continuation-in-part of application No. 14/929,593, filed on Nov. 2, 2015, now abandoned.
(60) Provisional application No. 62/077,204, filed on Nov. 8, 2014.

(51) Int. Cl. F03D 3/06; F03B 3/12; F03D 3/00; F03D 9/25

(52) U.S. Cl. CPC F03D 3/067; F03B 3/121; F03D 3/005; F05D 2240/30; F05D 2210/11; F05D 2210/12; F03D 9/25

(57) ABSTRACT

Apparatus and method derive useful energy from kinetic energy of a fluid, such as air or water, flowing in an existing direction of flow. A rotor carries impeller blade assemblies in circumferentially spaced apart positions about an axis of rotation. Vanes are carried by the impeller blade assemblies for unrestricted free pivotal movement between stops that establish a first position wherein a vane is oriented for being driven by the flow of fluid to rotate the rotor in a desired direction of rotation, and a second position wherein the vane is precluded from an orientation in which the flow of fluid could establish a force tending to retard rotation of the rotor in the desired direction, thus facilitating rotation of the rotor in the desired direction of rotation, independent of the direction of flow of the air or water, while the apparatus remains immersed in a single selected orientation within the flowing fluid.

This application is a continuation-in-part of U.S. patent application Ser. No. 14/929,593, filed Nov. 2, 2015, which claims the benefit of U.S. Provisional Patent Application Ser. No. 62/077,204, filed Nov. 8, 2014, the subject matter of which is incorporated herein by reference thereto.

The present invention relates generally to apparatus and method for deriving useful energy from kinetic energy available in a flowing fluid, such as air or water, flowing in an existing direction of flow and pertains, more specifically, to the construction and use of a turbine for harnessing energy available in wind and in moving water, known collectively as aero-aquatic kinetic energy.

Wind energy conventionally is harnessed by wind turbines rotating about either a horizontal or a vertical axis of rotation. A horizontal axis wind turbine usually requires a tail fin responsive structure to adjust the turbine direction relative to the existing direction of flow of the wind in which the turbine is operated in order to maximize effectiveness in deriving useful energy from the kinetic energy available in the wind.

Vertical axis wind turbines have been developed in an effort to capture available wind energy independent of wind direction, without the necessity for re-orienting the turbine to match wind direction. While vertical axis wind turbines tend to be aesthetically more pleasing and better adapted for more versatile installations, vertical axis wind turbines are less efficient and require more maintenance than conventional horizontal axis wind turbines. Thus, the efficiency of a vertical axis wind turbine suffers from the fact that while one side of the turbine is being driven by the wind, the opposite side of the turbine must move against the direction of the wind, resulting in undue turbulence and reduced efficiency. In addition, a tendency to lift the impeller elements of the wind turbine during operation leads to excessive wear and the requirement for more frequent maintenance.

Water energy conventionally is harnessed either by impulse-type or reaction-type water turbines. Impulse-type water turbines are highly efficient since only the part of an impeller element that effects rotation of the turbine is exposed to the flow of water. Reaction-type water turbines might be submerged to harness hydro-kinetic energy and thus capture the hydro-kinetic energy that exists in any flowing water; however, the use of reaction-type water turbines is limited primarily due to the lack of scalability. Thus, scalability is limited due to extreme harsh water thrust caused by the collision with extreme harsh conditions encountered within the flow of water in which the turbine is submerged during operation of the turbine.

The present invention recognizes that the major drawbacks of vertical wind turbines and reaction-type water turbines are similar in that these drawbacks are related to turbulence caused by the need for impeller elements of wind turbines to move against the flow of wind, or water turbines to withstand harsh turbine thrust during turbine operation. Accordingly, the present invention addresses that technical issue and, in doing so, attains several objects and advantages, some of which are summarized as follows: Reduces turbulence experienced during the operation of a turbine immersed in a flow of fluid, such as air or water, to more effectively derive usable energy from the flow of fluid in any existing direction of flow; simplifies the design and construction of turbines employed to capture usable energy from kinetic energy available in a flowing fluid, such as air or water flowing in any existing direction of flow; enables a turbine immersed in a fluid flowing in an existing direction of flow to rotate in a single direction of rotation regardless of the existing direction of flow of the fluid, without requiring a change in the orientation of the turbine relative to the existing direction of flow of the fluid; increases effectiveness and efficiency in deriving usable energy from wind and water moving in any existing direction of flow; increases reliability and reduces requirements for maintenance in turbines used in connection with deriving useful energy from wind and water sources; reduces significantly potential eco-environmental damage to airborne and waterborne wildlife; provides safe, efficient and reliable operation over an extended service life.

The above objects and advantages, as well as further objects and advantages, are attained by the present invention which may be described briefly as apparatus for immersion in a selected orientation within a fluid flowing in an existing direction of flow to derive useful energy from kinetic energy of the fluid flowing in the existing direction of flow, the apparatus comprising: a rotor constructed for rotation in a given direction of rotation about a prescribed axis of rotation upon immersion in the fluid flowing in the existing direction of flow; a plurality of impeller blade assemblies carried by the rotor, spaced apart circumferentially about the prescribed axis of rotation, each impeller blade assembly having a leading side and a trailing side trailing the leading side with respect to the given direction of rotation of the rotor; a first vane mounted upon a first corresponding impeller blade assembly of the plurality of impeller blade assemblies for unrestrained free pivotal movement about a pivotal axis spaced radially outwardly from the prescribed axis of rotation and extending substantially parallel to the prescribed axis of rotation, between a first position wherein the first vane extends radially inwardly from the pivotal axis toward the prescribed axis of rotation, in juxtaposition with a radial plane extending through the prescribed axis of rotation, adjacent the trailing side of the first corresponding impeller blade assembly, and a second position wherein the first vane extends radially outwardly from the pivotal axis away from the prescribed axis of rotation, in juxtaposition with the radial plane, adjacent the trailing side of the first corresponding impeller blade assembly; a first stop located for precluding pivotal movement of the first vane beyond the radial plane in a direction corresponding to the given direction of rotation when the first vane is in the first position; and a second stop located for precluding pivotal movement of the first vane beyond the radial plane in a direction corresponding to the given direction of rotation when the first vane is in the second position; whereby upon immersion of the rotor in the fluid flowing in the existing direction of flow, with the prescribed axis of rotation oriented cross-wise to the existing direction of flow, the first vane, when in the first position, is oriented for being driven by the fluid flowing in the existing direction of flow against the first vane into rotation about the prescribed axis of rotation, while a corresponding further vane carried by a further impeller blade assembly spaced circumferentially from the first corresponding impeller blade assembly and placed transversely across from the first corresponding impeller blade assembly is moved freely into the second position, in response to the flow of fluid flowing in the existing direction to be oriented in alignment with the existing direction of flow, and is precluded from movement beyond a corresponding radial plane in a direction corresponding to the given direction of rotation, thereby facilitating rotation of the rotor in the same given direction of rotation about the prescribed axis of rotation in response to the flow of fluid in any existing direction of flow cross-wise to the prescribed axis of rotation while the apparatus remains oriented in the selected orientation.

In addition, the present invention provides a method for deriving useful energy from kinetic energy of a fluid flowing in an existing direction of flow, the method comprising: constructing a rotor for rotation in a given direction of rotation about a prescribed axis of rotation upon immersion in a selected orientation in the fluid flowing in the existing direction of flow; providing a plurality of impeller blade assemblies carried by the rotor, spaced apart circumferentially about the prescribed axis of rotation, with each impeller blade assembly having a leading side and a trailing side trailing the leading side with respect to the given direction of rotation of the rotor; mounting a first vane upon a first corresponding impeller blade assembly of the plurality of impeller blade assemblies for unrestrained free pivotal movement about a pivotal axis spaced radially outwardly from the prescribed axis of rotation and extending substantially parallel to the prescribed axis of rotation, between a first position wherein the first vane extends radially inwardly from the pivotal axis toward the prescribed axis of rotation, in juxtaposition with a radial plane extending through the prescribed axis of rotation, adjacent the trailing side of the first corresponding impeller blade assembly, and a second position wherein the first vane extends radially outwardly from the pivotal axis away from the prescribed axis of rotation, in juxtaposition with the radial plane, adjacent the trailing side of the first corresponding impeller blade assembly; precluding pivotal movement of the first vane beyond the radial plane in the direction corresponding to the given direction of rotation when the first vane is in the first position; precluding pivotal movement of the first vane beyond the trailing side of the first corresponding impeller blade assembly in the direction of the leading side of the corresponding impeller blade assembly when the first vane is in the second position; and immersing the rotor in the fluid flowing in the existing direction of flow, with the prescribed axis of rotation oriented cross-wise to the existing direction of flow, such that the first vane, when in the first position, will be oriented for being driven by the fluid flowing in the existing direction of flow against the first vane into rotation about the prescribed axis of rotation, while a corresponding further vane carried by a further impeller blade assembly spaced circumferentially from the first corresponding impeller blade assembly and placed transversely across from the first corresponding impeller blade assembly is moved freely into the second position in response to the flow of fluid flowing in the existing direction to be oriented in alignment with the existing direction of flow, and is precluded from movement beyond a corresponding radial plane in a direction corresponding to the given direction of rotation, thereby facilitating rotation of the rotor in the same given direction of rotation about the prescribed axis of rotation in response to the flow of fluid in any existing direction of flow cross-wise to the prescribed axis of rotation while the rotor remains oriented in the selected orientation.

The present invention will be understood more fully, while still further objects and advantages will become apparent, in the following detailed description of preferred embodiments of the invention illustrated in the accompanying drawing, in which:

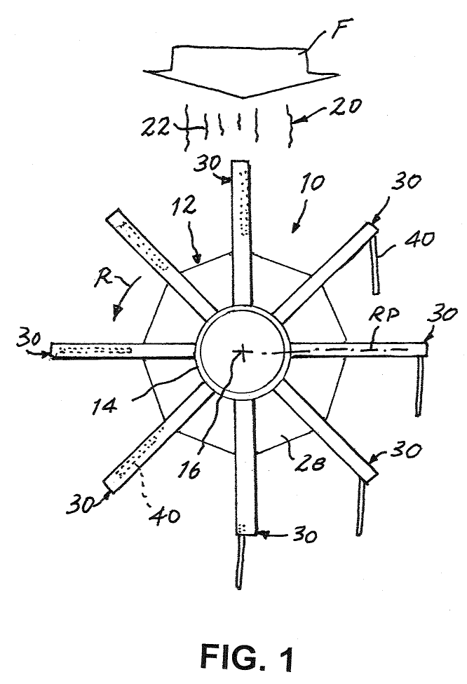

FIG. 1 is a somewhat diagrammatic, top plan view of an apparatus constructed for operation in accordance with the present invention;

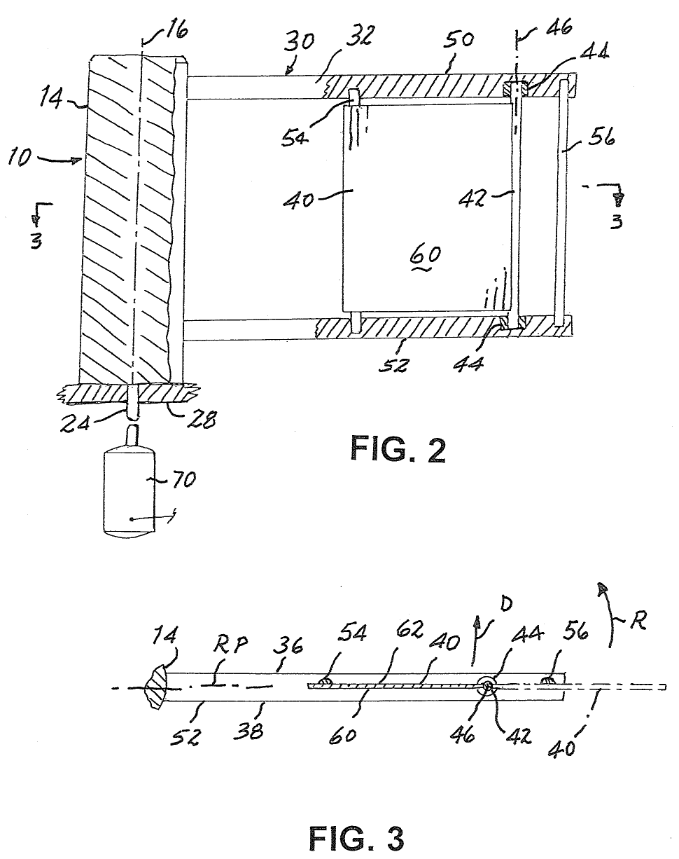

FIG. 2 is an enlarged fragmentary front elevational view of component parts of the apparatus;

FIG. 3 is an enlarged fragmentary cross-sectional view taken alone line 3-3 in FIG. 2;

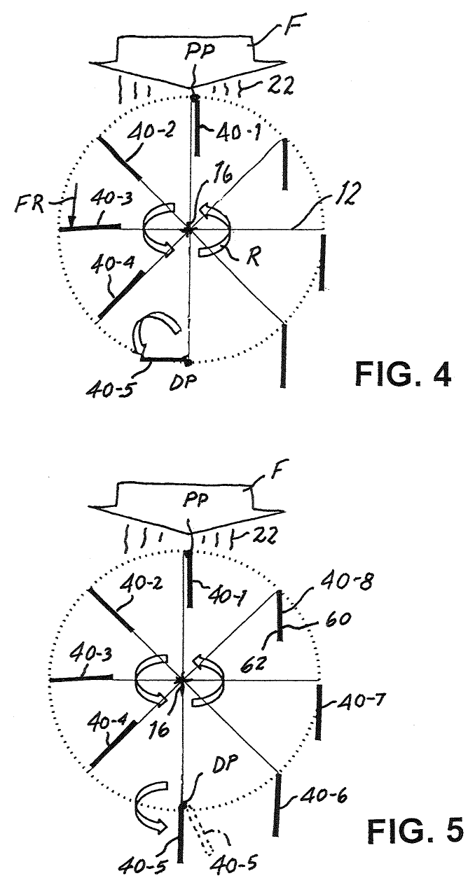

FIG. 4 is a largely diagrammatic illustration of component parts of the apparatus in one stage during one mode of operation;

FIG. 5 is a largely diagrammatic illustration similar to FIG. 4 and showing the component parts in another stage during the illustrated mode of operation;

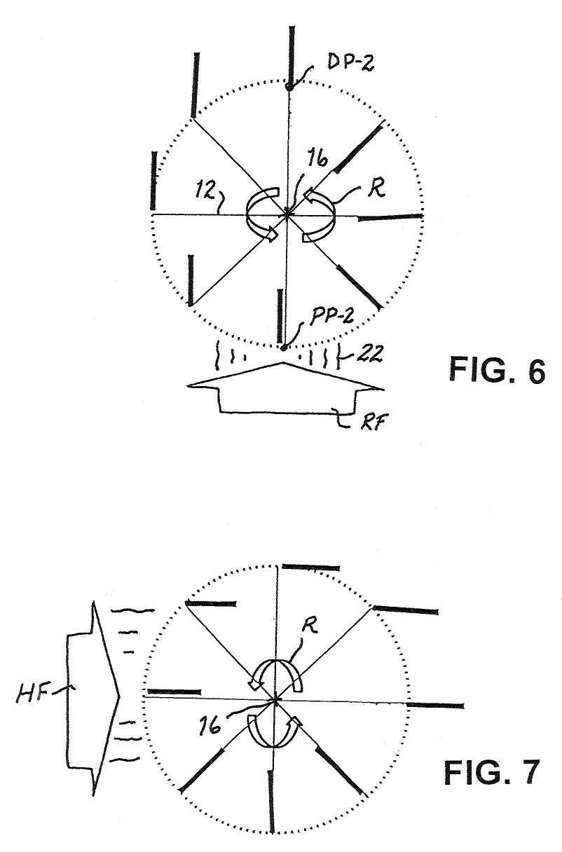

FIG. 6 is a largely diagrammatic illustration similar to FIG. 4 and showing the component parts in another mode of operation; and

FIG. 7 is a largely diagrammatic illustration of component parts of the apparatus being operated in accordance with another feature of the present invention.

Referring now to the drawing, and especially to FIGS. 1 through 3 thereof, an exemplary apparatus constructed in accordance with the present invention is shown at 10 and is seen to include a turbine 12 having a rotor 14 constructed for rotation in a given direction of rotation R about a prescribed axis of rotation 16. Turbine 12 is shown immersed in a stream 20 of fluid 22, which may be either air, where stream 20 is wind, or water, where stream 20 is a natural river or stream, tidal water, or water directed by a conduit (not shown) to turbine 12. Turbine 12 includes a central shaft 24 which, in this instance, is placed in a vertical orientation, and shaft 24 is journaled within a base 28 for rotation about axis of rotation 16 which itself is oriented in the vertical direction, cross-wise to an existing direction of flow F of fluid 22, the flow F of fluid 22 being in a generally horizontal direction.

A plurality of impeller blade assemblies 30 are carried by rotor 14, spaced apart circumferentially around shaft 24 and affixed to rotor 14 for rotation with shaft 24 about axis of rotation 16. In the preferred construction, each impeller blade assembly 30 includes a frame 32 having a leading side 36 and a trailing side 38 trailing the leading side 36 with respect to the given direction of rotation R and carries at least one vane 40 mounted upon an axle 42 journaled at pivotal connections 44 on a corresponding frame 32 for unrestricted, free pivotal movement about a pivotal axis 46 spaced radially outwardly from axis of rotation 16, and extending parallel to axis of rotation 16 between a first position, wherein vane 40 extends radially inwardly from pivotal axis 46 toward axis of rotation 16, in juxtaposition with trailing side 38 of frame 32 of impeller blade assembly 30, as seen in full lines in FIG. 3, substantially parallel to a radial plane RP passing through axis of rotation 16, and a second position, wherein vane 40 extends radially outwardly from pivotal axis 46, away from axis of rotation 16, in juxtaposition with radial plane RP, adjacent the trailing side 38 of frame 32 of impeller blade assembly 30, as seen in phantom in FIG. 3. Each frame 32 includes upper and lower arms 50 and 52, respectively, which arms 50 and 52 carry pivotal connections 44 that, together with axle 42, mount the vane 40 for pivotal movement relative to corresponding frames 32.

Each impeller blade assembly 30 includes a stop arrangement having a first stop, shown in the form of a first bar 54 extending between, and affixed to, upper and lower arms 50 and 52, bar 54 being located for precluding pivotal movement of vane 40 beyond the radial plane RP, in direction D, corresponding to the given direction of rotation R, when the vane 40 is in the first position, and a second stop, shown in the form of a second bar 56, extending between, and affixed to, upper and lower arms 50 and 52. Bar 56 is located for precluding pivotal movement of vane 40 beyond Radial plane RP, in the direction D toward leading side 36, when vane 40 is in the second position.

Referring now to FIGS. 4 and 5, as well as to FIGS. 1 through 3, with turbine 12 located within the flow of fluid 22, and axis of rotation 16 oriented in the vertical direction, so that the flow of fluid 22 is in the generally horizontal direction F, cross-wise to the vertical direction, as shown, a first vane, depicted as vane 40-1, is located at proximal point PP, with respect to direction F, and is biased by the flow of fluid 22 into the first position wherein vane 40-1 is retained by engagement with corresponding first bar 54, as is each further vane, depicted as vane 40-2, 40-3 and 40-4 biased by the flow of fluid 22 against a corresponding first bar 54 as turbine 12 is rotated in direction R by a rotational force FR exerted by the flow of fluid 22 acting against each vane 40-2, 40-3 and 40-4 and driving rotor 14 in direction R until each vane 40-1, 40-2, and 40-3 reaches distal point DP. Upon arrival at distal point DP, each vane, as depicted by vane 40-5, is biased, by the flow of fluid 22 into the second position wherein that vane 40-5 is aligned with direction F so as to present minimal resistance to the flow of fluid 22 and to avoid the establishment of forces that could retard rotation of turbine 12 in direction R.

As rotation of turbine 12 in direction R continues, each vane, as depicted by vanes 40-6, 40-7 and 40-8, will be maintained in alignment with direction F, by virtue of the unrestrained, free pivotal movement of each vane about a corresponding pivotal axis 46. Each vane 40 has a forward face 60 confronting the oncoming flow of fluid 22, each face 60 advantageously having a flat configuration. In addition, each vane 40 has a flat rearward face 62. The flat configuration of each face 60 and 62 avoids forces that can create thrust in directions that would resist rotation of turbine 12 in direction R. Vanes 40 are constructed relatively thin between faces 60 and 62, thereby presenting minimal resistance when aligned with the flow of fluid 22. Further, by precluding pivotal movement of each vane 40 beyond the second position, as depicted in phantom in FIG. 5, as each vane 40 reaches distal point DP and is engaged by second bar 56, as depicted in full lines in FIGS. 3 and 5, thrust forces tending to retard rotation of turbine 12 in direction R are precluded. Moreover, the thin, flat configuration of each vane 40 renders the vanes 40 simple in construction for ease and economy of manufacture.

Turning now to FIG. 6, apparatus 10 is shown diagrammatically in operation where the flow of fluid 22 is in direction RF, that is, opposite to direction F illustrated in FIGS. 4 and 5. In this mode of operation, proximal point now becomes located at PP-2, while distal point now becomes located at DP-2. Turbine 12 continues to be driven in the same direction R, as described above in connection with FIGS. 4 and 5. Thus, apparatus 10 is constructed for rotation in the same direction R when exposed to the flow of fluid 22 in any direction cross-wise to axis of rotation 16 without requiring a change in the originally selected orientation of turbine 12, rendering apparatus 10 exceptionally versatile for installation at a wide variety of venues, including those sites where apparatus 10 may be exposed to frequent changes in the direction off low of the fluid available at a particular site.

Usable energy is derived from the kinetic energy available in the flow of fluid 22 by coupling an energy recovery system to shaft 24. Thus, as seen in FIG. 2, an electric generator 70 is coupled with shaft 24 to recover usable energy made available during operation of apparatus 10.

In installations where apparatus 10 may be subjected to upward and downward variations in fluid flow directions, such as may be encountered in a river or stream of water, or in tidal water, or during wind gusts, apparatus 10 may be installed with shaft 24 and, consequently, axis of rotation 16, oriented in a generally horizontal direction, cross-wise to the direction of flow of the fluid, as illustrated at direction HF in FIG. 7. In this manner, all of the attributes of apparatus 10 are realized, with the added versatility of being able to capture energy available through such up and down variations in fluid flow.

It is noted that the above-described construction enables vanes 40 to have a simple, flat configuration at faces 60 and 62, calling for no elaborate contours in order to gain maximum performance. Accordingly, manufacture and installation are attained economically. Further, the open frame and pivoted vane arrangement militates against damage to airborne wildlife, where the present invention is applied to a wind turbine, or aquatic wildlife, where the invention is applied to a water turbine.

It will be seen that the present invention attains all of the objects and advantages summarized above, namely: Reduces turbulence experienced during the operation of a turbine immersed in a flow of fluid, such as air or water, to more effectively derive usable energy from the flow of fluid in any existing direction of flow; simplifies the design and construction of turbines employed to capture usable energy from kinetic energy available in a flowing fluid, such as air or water flowing in any existing direction of flow; enables a turbine immersed in a fluid flowing in an existing direction of flow to rotate in a single direction of rotation regardless of the existing direction of flow of the fluid, without requiring a change in the orientation of the turbine relative to the existing direction of flow of the fluid; increases effectiveness and efficiency in deriving usable energy from wind and water moving in any existing direction of flow; increases reliability and reduces requirements for maintenance in turbines used in connection with deriving useful energy from wind and water sources; reduces significantly potential eco-environmental damage to airborne and waterborne wildlife; provides safe, efficient and reliable operation over an extended service life.

It is to be understood that the above detailed description of preferred embodiments of the invention is provided by way of example only. Various details of design, construction and procedure may be modified without departing from the true spirit and scope of the invention as set forth in the appended claims.

The embodiments of the invention in which an exclusive property or privilege is claimed are defined as follows:

1. Apparatus for immersion in a selected orientation within a fluid flowing in an existing direction of flow to derive useful energy from kinetic energy of the fluid flowing in the existing direction of flow, the apparatus comprising:
a rotor constructed for rotation in a given direction of rotation about a prescribed axis of rotation upon immersion in the fluid flowing in the existing direction of flow;
a plurality of impeller blade assemblies carried by the rotor, spaced apart circumferentially about the prescribed axis of rotation, each impeller blade assembly having a leading side and a trailing side trailing the leading side with respect to the given direction of rotation of the rotor;
a first vane mounted upon a first corresponding impeller blade assembly of the plurality of impeller blade assemblies for unrestrained free pivotal movement about a pivotal axis spaced radially outwardly from the prescribed axis of rotation and extending substantially parallel to the prescribed axis of rotation, between a first position wherein the first vane extends radially inwardly from the pivotal axis toward the prescribed axis of rotation, in juxtaposition with a radial plane extending through the prescribed axis of rotation, adjacent the trailing side of the first corresponding impeller blade assembly, and a second position wherein the first vane extends radially outwardly from the pivotal axis away from the prescribed axis of rotation, in juxtaposition with the radial plane, adjacent the trailing side of the first corresponding impeller blade assembly;
a first stop located for precluding pivotal movement of the first vane beyond the radial plane in a direction corresponding to the given direction of rotation when the first vane is in the first position; and
a second stop located for precluding pivotal movement of the first vane beyond the radial plane in a direction corresponding to the given direction of rotation when the first vane is in the second position;
whereby upon immersion of the rotor in the fluid flowing in the existing direction of flow, with the prescribed axis of rotation oriented cross-wise to the existing direction of flow, the first vane, when in the first position, is oriented for being driven by the fluid flowing in the existing direction of flow against the first vane into rotation about the prescribed axis of rotation, while a corresponding further vane carried by a further impeller blade assembly spaced circumferentially from the first corresponding impeller blade assembly and placed transversely across from the first corresponding impeller blade assembly is moved freely into the second position, in response to the flow of fluid flowing in the existing direction to be oriented in alignment with the existing direction of flow, and is precluded from movement beyond corresponding radial plane in a direction corresponding to the given direction of rotation, thereby facilitating rotation of the rotor in the same given direction of rotation about the prescribed axis of rotation in response to the flow of fluid in any existing direction of flow cross-wise to the prescribed axis of rotation while the apparatus remains oriented in the selected orientation.

2. The apparatus of claim 1 wherein each vane has a face for confronting the flow of fluid when the vane is in the first position, the face having a substantially flat configuration.

3. The apparatus of claim 1 including an electric generator coupled to the rotor.

4. The apparatus of claim 1 wherein upon immersion of the rotor within the fluid flowing in the existing direction, the prescribed axis of rotation extends in a vertical direction, transverse to the existing direction of flow of the fluid.

5. The apparatus of claim 4 wherein each vane has a face for confronting the flow of fluid when the vane is in the first position, the face having a substantially flat configuration.

6. The apparatus of claim 1 wherein upon immersion of the rotor within the fluid flowing in the existing direction, the prescribed axis of rotation extends in a horizontal direction, transverse to the existing direction of flow of the fluid.

7. The apparatus of claim 6 wherein each vane has a face for confronting the flow of fluid when the vane is in the first position, the face having a substantially flat configuration.

8. The apparatus of claim 1 wherein each vane has a first face for confronting the flow of fluid when the vane is in the first position, and a second face opposite the first face, both the first face and the second face having a substantially flat configuration, the second face being substantially parallel to the first face.

9. A method for deriving useful energy from kinetic energy of a fluid flowing in an existing direction of flow, the method comprising:
constructing a rotor for rotation in a given direction of rotation about a prescribed axis of rotation upon immersion in a selected orientation in the fluid flowing in the existing direction of flow;
providing a plurality of impeller blade assemblies carried by the rotor, spaced apart circumferentially about the prescribed axis of rotation, with each impeller blade assembly having a leading side and a trailing side trailing the leading side with respect to the given direction of rotation of the rotor;
mounting a first vane upon a first corresponding impeller blade assembly of the plurality of impeller blade assemblies for unrestrained free pivotal movement about a pivotal axis spaced radially outwardly from the prescribed axis of rotation and extending substantially parallel to the prescribed axis of rotation, between a first position wherein the first vane extends radially inwardly from the pivotal axis toward the prescribed axis of rotation, in juxtaposition with a radial plane extending through the prescribed axis of rotation, adjacent the trailing side of the first corresponding impeller blade assembly, and a second position wherein the first vane extends radially outwardly from the pivotal axis away from the prescribed axis of rotation, in juxtaposition with the radial plane, adjacent the trailing side of the first corresponding impeller blade assembly;
precluding pivotal movement of the first vane beyond the radial plane in a direction corresponding to the given direction of rotation when the first vane is in the first position;
precluding pivotal movement of the first vane beyond the radial plane in the direction corresponding to the given direction of rotation when the first vane is in the second position; and
immersing the rotor in the fluid flowing in the existing direction of flow, with the prescribed axis of rotation oriented cross-wise to the existing direction of flow, such that the first vane, when in the first position, will be oriented for being driven by the fluid flowing in the existing direction of flow against the first vane into rotation about the prescribed axis of rotation, while a corresponding further vane carried by a further impeller blade assembly spaced circumferentially from the first corresponding impeller blade assembly and placed transversely across from the first corresponding impeller blade assembly is moved freely into the second position in response to the flow of fluid flowing in the existing direction to be oriented in alignment with the existing direction of flow, and is precluded from movement beyond a corresponding radial plane in a direction corresponding to th given direction of rotation, thereby facilitating rotation of the rotor in the same given direction of rotation about the prescribed axis of rotation in response to the flow of fluid in any existing direction of flow cross-wise to the prescribed axis of rotation while the rotor remains oriented in the selected orientation.

10. The method of claim 9 including coupling an electric generator to the rotor.

11. The method of claim 9 wherein the fluid is air.

12. The method of claim 9 wherein the fluid is water.

13. The method of claim 9 wherein upon immersion of the rotor, extending the prescribed axis of rotation in a vertical direction, transverse to the given direction of flow of the fluid.

14. The method of claim 13 wherein the fluid is air.

15. The method of claim 13 wherein the fluid is water.

16. The method of claim 9 wherein upon immersion of the rotor, extending the prescribed axis of rotation in a horizontal direction, crosswise to the given direction of flow of the fluid.

17. The method of claim 16 wherein the fluid is air.

18. The method of claim 16 wherein the fluid is water.
